(19) United States
(12) Patent Application Publication
(10) Pub. No.: US 2025/0170715 A1
(43) Pub. Date: May 29, 2025

(54) MANIPULATOR SYSTEM, MANAGEMENT DEVICE FOR MANAGING OPERATION STATE OF MANIPULATOR, AND MANAGEMENT METHOD FOR MANAGING OPERATION STATE OF MANIPULATOR

(71) Applicant: Hitachi, Ltd., Tokyo (JP)

(72) Inventors: Masahiro KAMIGAKI, Tokyo (JP); Motohiro TAKAHASHI, Tokyo (JP)

(21) Appl. No.: 18/931,582

(22) Filed: Oct. 30, 2024

(30) Foreign Application Priority Data
Nov. 29, 2023 (JP) 2023-201902

(51) Int. Cl. B25J 9/16

(52) U.S. Cl. CPC B25J 9/1653

(57) ABSTRACT

A manipulator system includes: a memory unit that stores a mass of the manipulator before the operation of manipulator and a spring coefficient of the manipulator before the operation of manipulator; a reception unit that receives an input signal that drives the manipulator, and an output signal of the manipulator that is operated in response to the input signal; a calculation unit that calculates a mass of the manipulator during an operation of the manipulator and a spring coefficient of the manipulator during an operation of the manipulator using the input signal and the output signal; and an identification unit that identifies an operation state of the manipulator by comparing the mass of the manipulator before the operation of the manipulator and the spring coefficient of the manipulator before the operation of manipulator both of which the memory unit stores.

### CLAIM OF PRIORITY

The present application claims priority from Japanese Patent application serial no. 2023-201902 filed on Nov. 29, 2023, the content of which is hereby incorporated by reference into this application.

### TECHNICAL FIELD

The present invention relates to a manipulator system for manipulating an object, a management device for managing an operation state of a manipulator, and a management method for managing an operation state of a manipulator.

### BACKGROUND ART

To perform a manipulation such as gripping or moving of various objects, a remote control manipulator has been used. For example, there has been known a micro manipulator that treats an extremely fine object such as a cell that is difficult for a human to directly manipulate. To realize a complicated operation, it is considered that a human manipulates an object by performing a remote control of a manipulator. In the manipulator that performs such a remote control, to enable a human to perform a more fine and delicate operation and to prevent a breakage of a target object or a mechanism, there has been a demand for informing a user of a reaction at the time of bringing the manipulator into contact with an object or at the time of manipulating the object or informing the user of a state where the manipulator is in contact with the target object.

On the other hand, in a case where a particularly small object is treated as a target, it is difficult to directly mount a sensor that detects a contact or a sensor that measures a reaction generated at the time of gripping the object on a distal end of the manipulator. Accordingly, there has been a demand for detecting a state such as a contact state by any suitable method and by providing the detected state to the user thus enhancing safety.

As a method of informing contacting between the manipulator and the object, Patent Literature 1 discloses a method where an oscillator and a oscillation detection sensor are mounted on the manipulator, and it is determined that the manipulator is brought into contact with the object in a case where a deviation between an output frequency of the oscillator and an oscillation frequency detected by the oscillation detection sensor becomes a certain value or more, and a user is informed of such a contact. Further, Patent Literature 1 discloses a method that uses sound and light as a means for informing the user of such a contact.

### CITATION LIST

### Patent Literature

Patent Literature 1: Japanese Unexamined Patent Application Publication No. 2005-143961

### SUMMARY OF INVENTION

### Technical Problem

According to the technique disclosed in Patent Literature 1, the user who operates the manipulator can confirm whether or not manipulator is brought into contact with the object by making use of sound or light.

On the other hand, by mounting the sensor or the actuator for detecting a contact such as the sensor that oscillates the manipulator or the oscillation detection sensor on the manipulator, there arises a drawback that a cost is pushed up. Further, to easily realize a complicated operation, the method is required to provide a larger number of information such as a state that the manipulator grips the target object and moves the target object. However, in the method described in Patent Literature 1, the provided information is limited to the contacting with the target object and hence, the complicated operation cannot be easily realized.

It is an object of the present invention to provide a technique where that enables the detection of a gripping state in addition to a contact state with respect to a target object in a manipulator.

### Solution to Problem

The present invention provides a manipulator system provided with a drive means that drives a manipulator and a measurement means that measures a position of the manipulator. The manipulator system includes:
a memory unit configured to store a mass of the manipulator before the operation of the manipulator and a spring coefficient of the manipulator before the operation of the manipulator; a reception unit configured to receive an input signal that drives the manipulator, and an output signal of the manipulator that is operated in response to the input signal; a calculation unit configured to calculate a mass of the manipulator during the operation of the manipulator and a spring coefficient of the manipulator during the operation of the manipulator using the input signal and the output signal; and an identification unit configured to identify an operation state of the manipulator by comparing the mass of the manipulator before the operation of the manipulator and the spring coefficient of the manipulator before the operation of the manipulator both of which the memory unit stores, and the mass of the manipulator during the operation of the manipulator and the spring coefficient of the manipulator during the operation of the manipulator both of which the calculation unit calculates with each other, respectively.

The present invention also provides a management device that manages an operation state of a manipulator. The management device includes: a memory unit configured to store a mass of the manipulator before the operation of manipulator and a spring coefficient of the manipulator before the operation of manipulator; a reception unit configured to receive an input signal that drives the manipulator, and an output signal of the manipulator that is operated in response to the input signal; a calculation unit configured to calculate a mass of the manipulator during an operation of the manipulator and a spring coefficient of the manipulator during an operation of the manipulator using the input signal and the output signal; and an identification unit configured to identify an operation state of the manipulator by comparing the mass of the manipulator before the operation of manipulator and the spring coefficient of the manipulator before the operation of manipulator both of which the memory unit stores, and the mass of the manipulator during the operation of the manipulator and the spring coefficient of the manipulator during the operation of the manipulator both of which the calculation unit calculates with each other, respectively.

The present invention also includes a management method for managing an operation state of a manipulator. The management method includes the steps of: storing a mass of the manipulator before the operation of manipulator and a spring coefficient of the manipulator before the operation of manipulator; receiving an input signal that drives the manipulator, and an output signal of the manipulator that is operated in response to the input signal; calculating a mass of the manipulator during an operation of the manipulator and a spring coefficient of the manipulator during an operation of the manipulator using the input signal and the output signal; and identifying an operation state of the manipulator by comparing the mass of the manipulator before the operation of manipulator and the spring coefficient of the manipulator before the operation of manipulator both of which are stored, and the mass of the manipulator during the operation of the manipulator and the spring coefficient of the manipulator during the operation of the manipulator both of which are calculated with each other, respectively.

### Advantageous Effects of Invention

According to the present invention, in a manipulator, it is possible to detect a gripping state in addition to a contact state with respect to a target object.

### BRIEF DESCRIPTION OF DRAWINGS

FIG. 1 is a configurational view of a manipulator system according to an embodiment of a present invention.

FIG. 2 is a flowchart illustrating one example of processing according to the embodiment of the present invention.

FIG. 3 is a schematic view of the manipulator system according to the embodiment of the present invention when the manipulator system is a non-contact state.

FIG. 4 is a schematic view of the manipulator system according to the embodiment of the present invention when the manipulator system is in a contact state.

FIG. 5 is a schematic view of the manipulator system according to the embodiment of the present invention when the manipulator system is in a gripped state.

FIG. 6 is a view illustrating an example of a screen that displays information provided to a user in the embodiment according to the present invention.

FIG. 7 is a flowchart illustrating the flow of signal processing in a computer according to the embodiment of the present invention.

### DESCRIPTION OF EMBODIMENTS

Hereinafter, an embodiment of a manipulator system of this disclosure is described with reference to drawings and the like. The following description describes a specific example of the content of the present invention, and the present invention is not limited by such description, and various changes and modifications of the present invention by a person skilled are conceivable within a range of a technical concept disclosed in the present specification.

### First Embodiment

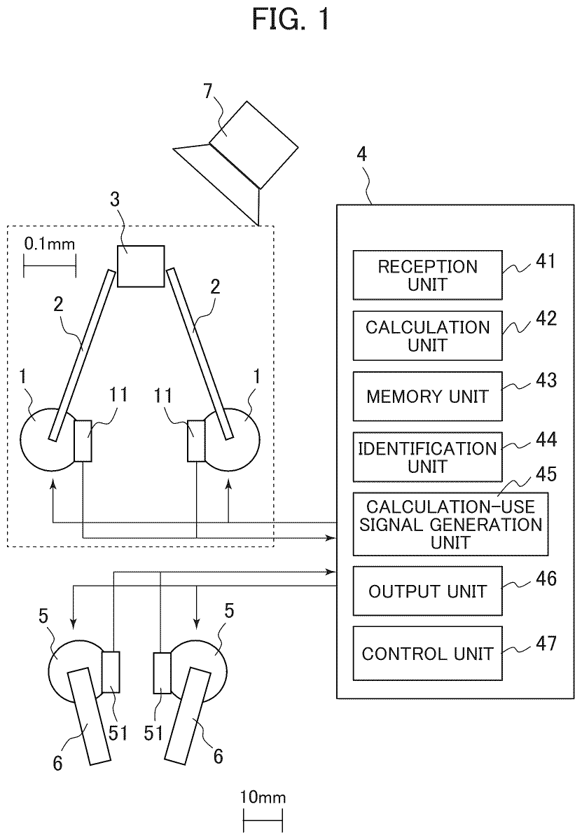

FIG. 1 illustrates a configurational example of a manipulator system according to an embodiment of the present invention. The manipulator system is a device that includes a drive unit 1, end effectors 2, and a computer 4, and operates a manipulation target object 3. A portion surrounded by a dotted line is illustrated in an enlarged manner. The drive unit 1 includes drive unit output angle measuring units 11 that measure an angle of the drive unit 1 and can measure an output angle.

The manipulator system is the device that can operate an extremely fine target object whose size makes it difficult for a human to directly operate the target object with his/her hands. As an example of the manipulation target object 3, a container that contains cells or the like is named.

The manipulator system includes: a remote control device drive unit 5 and a remote control device operating unit 6 that are driven using a remote control performed by a human and receive the remote control; and an observation means 7 such as an optical microscope or an electron microscope for example, that observes a manipulation target object. The remote control device also includes a remote control device drive unit angle measuring unit 51 that measures an output angle of the remote control device drive unit 5. The remote control device drive unit angle measuring unit 51 can measure an output angle. A user operates the remote control device operating unit 6 with his/her hand while confirming an image of the observed manipulation target object 3 by the observation means 7. The remote control device drive unit 5 is operated in response to such an operation, and an output angle is acquired by the remote control device drive unit angle measuring unit 51. The drive unit 1 of the manipulator system is operated corresponding to an operation amount acquired by the remote control device drive unit angle measuring unit 51.

Besides a case where the manipulator system receives an operation instruction by a remote control, the manipulator system may also perform a predetermined operation automatically. Further, the manipulator system may automatically generate an operation instruction based on information such as an image acquired by the observation means 7 or the like and may perform an operation in accordance with the operation instruction.

The computer 4 is a management device that manages an operation state of the manipulator. The computer 4 includes: a reception unit 41 that receives an input signal to the drive unit 1 and an output angle from the drive unit 1; a calculation unit 42 that calculates a mass and a spring coefficient of the manipulator system during an operation of the manipulator system based on the signal that the reception unit receives; a memory unit 43 that stores and holds the mass and the spring coefficient of the manipulator system; an identification unit 44 that identifies an operation state by comparing the mass and the spring coefficient that the calculation unit 42 has estimated and the mass and the spring coefficient that the memory unit 43 holds to each other; a calculation-use signal generating unit 45 that adds a signal for assisting parameter estimation of the calculation unit to the input signal that is inputted to the drive unit; an output unit 46 that provides a user with such a state based on the operation state identified by the identification unit 44; and a control unit 47 that performs a control of an output of the manipulator system and a control of the remote control device of the user based on a signal of an operation instruction generated by a remote control of the user.

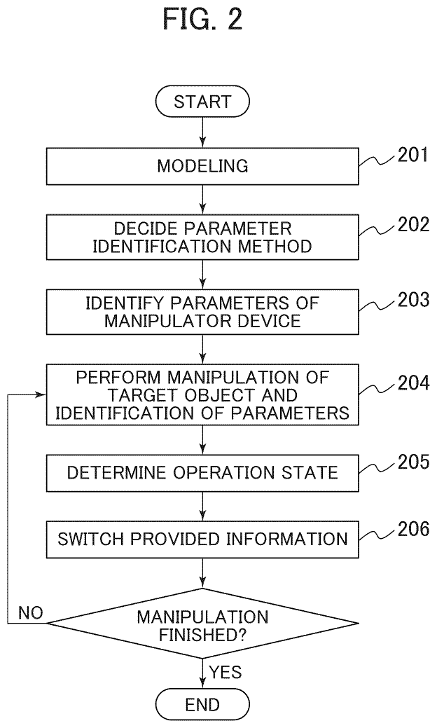

FIG. 2 is a flowchart illustrating the flow of the determination of the state in the manipulator system to which the present invention is applied. The flow of processing in accordance with FIG. 2 is as follows.

In step 201, modeling of a hardware of the manipulator system is performed. For example, modeling is performed on a transfer characteristic from a torque T to an output angle θ of the drive unit 1 of the manipulator system as expressed by a formula 1.

$$[ Formula 1 ]$$

$$\frac{θ ( s )}{τ ( s )} = \frac{G}{M {s}^{2} + Ds + K} \qquad ( 1 )$$

In the formula 1, s is a Laplace operator, G is a gain, M is a mass, D is damping, and K is a spring coefficient.

The torque is a torque that the drive unit 1 outputs in proportion to a signal inputted to the drive unit 1. The model expressed in the formula 1 is just one example, and it is desirable to use a model that is considered suitable for expressing the characteristic of the system to which the present invention is applied. For example, modeling of the entire control system is performed. The modeling may be performed from an instruction value of an angle or a force to a response value. Modeling in step 201 is performed only the first time as a preparation for performing operations in the manipulator system.

In step 202, next, before the operation of the manipulation target object 3 is actually performed using the manipulator system, a method of identifying parameters for performing identification of respective parameters in the formula 1 is decided. The processing in step 202 is performed only one time after modeling in step S201 is finished. One example of a method of estimating parameters in the calculation unit is described hereinafter.

To transform the model expressed in the formula 1 to a discrete model that can be processed by a computer using a bilinear transformation, the transformation is expressed by the formula 2.

$$[ Formula 2 ]$$

$$\frac{θ [ k ]}{τ [ k ]} = \frac{{B}_{0} + {B}_{1} {z}^{- 1} + {B}_{2} {z}^{- 2}}{{A}_{0} + {A}_{1} {z}^{- 1} + {A}_{2} {z}^{- 2}} \qquad ( 2 )$$

In the formula 2, z is an z operator, k is a discrete time, A0 to A2 and B0 to B2 are coefficients, and the respective coefficients are expressed by the following formula 3 to formula 8.

$$[ Formula 3 ]$$

$${A}_{0} = 4 M + 2 {DT}_{s} + {KT}_{s}^{2} \qquad ( 3 )$$

$$[ Formula 4 ]$$

$${A}_{1} = - 8 M + 2 {KT}_{s}^{2} \qquad ( 4 )$$

$$[ Formula 5 ]$$

$${A}_{2} = 4 M - 2 {DT}_{s} + {KT}_{s}^{2} \qquad ( 5 )$$

$$[ Formula 6 ]$$

$${B}_{0} = {GT}_{s}^{2} \qquad ( 6 )$$

$$[ Formula 7 ]$$

$${B}_{1} = 2 {GT}_{s}^{2} \qquad ( 7 )$$

$$[ Formula 8 ]$$

$${B}_{2} = {GT}_{s}^{2} \qquad ( 8 )$$

In the formula 3 to the formula 8, Ts indicates a sampling cycle of the control system.

Next, a method of estimating the parameters indicated in the formula 3 to the formula 8 at real time is described. A parameter vector P and a data vector D are defined by formula 9 and formula 10.

$$[ Formula 9 ]$$

$$P = {[ {A}_{1} / {A}_{0} , {A}_{2} / {A}_{0} , {B}_{0} / {A}_{0} , {B}_{1} / {A}_{0} , {B}_{2} / {A}_{0} ]}^{T} \qquad ( 9 )$$

$$[ Formula 10 ]$$

$$D = {[ - θ [ k - 1 ] , - θ [ k - 2 ] , τ [ k ] , τ [ k - 1 ] , τ [ k - 2 ] ]}^{T} \qquad ( 10 )$$

In this case, an estimated value Pe of the parameter at a point of time k is expressed by formula 11.

$$[ Formula 11 ]$$

$${P}_{e} [ k ] = {P}_{e} [ k - 1 ] + \frac{V [ k - 1 ] D [ k ]}{1 + {D}^{T} [ k ] V [ k - 1 ] D [ k ]} ( θ [ k ] - {D}^{T} [ k ] {P}_{e} [ k - 1 ] ) \qquad ( 11 )$$

In the formula 11, V [k] is a covariance matrix, and the covariance matrix V [k] is defined by formula 12.

$$[ Formula 12 ]$$

$$V [ k ] = V [ k - 1 ] - \frac{V [ k - 1 ] D [ k ] {D}^{T} [ k ] V [ k - 1 ]}{1 + {D}^{T} [ k ] V [ k - 1 ] D [ k ]} \qquad ( 12 )$$

An initial value of an estimated value Pe of the parameter is set to zero. Further, with respect to the initial values of a covariance matrix, it is effective to set a unit matrix as I and a coefficient γ as γI. In this case, it is preferable to empirically decide γ in accordance with a characteristic of the manipulator system.

A technique of sequentially estimating the parameters as expressed formula 11 and formula 12 is known as a sequential least squares method.

The parameters indicated in the formula 9 are estimated by the formula 11. The respective coefficients indicated in the formula 3 to formula 8 can be calculated using the parameters estimated by the formula 11 and the relational expressions in the formula 3 to formula 8.

In the formula 3 to the formula 5, the mass M, damping D and the spring coefficient K exist as variables. The number of unknown variables and the number of formulas are the same and hence, the mass M, damping D and the spring coefficient K can be calculated by using a simultaneous equation. Further, the gain G can be calculated by using either one of the formula 6 or the formula 8. With the use of the method that has been described heretofore, the mass M and the spring coefficient K of the manipulator system can be calculated using the respective parameters.

Although the method of estimating the parameters has been described heretofore, the method of estimating the parameters in the present invention is not limited to the above-mentioned description, and it is preferable to select a suitable technique corresponding to the method of modeling.

In step 203, the parameters of the manipulator itself are estimated by operating the manipulator system based on the model prepared by the above-mentioned steps, and the parameters are held in the memory unit 43. At this point of time, the operation of the manipulation target object is not performed, and the manipulator system is operated in a state where the manipulator system is not brought into contact with the object.

In the above-mentioned operation, a signal having frequency components in a wide band, for example, an M-sequence signal is used as an input to the manipulator.

The manipulator is driven using the M-sequence signal as an input signal, and the reception unit receives the input signal and the output angle of the manipulator. The calculation unit sequentially estimates the parameters by the method described in step 202 based on the signals that the reception unit receives.

In step 203, the manipulator system is operated only for a predetermined time, and the memory unit 43 holds average values of estimated value of masses M, dampings D, spring coefficients K and gain G estimated from the parameter estimated values at the respective points of time as the parameters at a non-contact state of the manipulatory system. The identification of the parameters in step 203 is performed only one time before the operation in the manipulator system is performed.

In step 204, the manipulator system performs a manipulation of a target object to be targeted. As an example of performing the manipulation of the target object, the description is made with respect to a method that drives the manipulator system by a remote control performed by a human. Hereinafter, processing steps 204 to 206 are repeatedly performed at the time of performing the remote control.

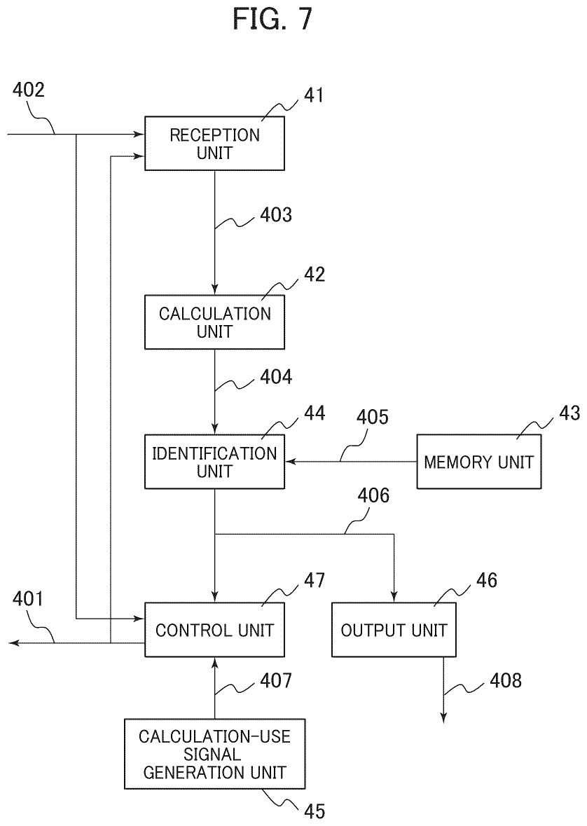

FIG. 7 illustrates the flow of a signal in the computer 4 in steps 204 to 206. Hereinafter, the description is made also with respect to FIG. 7. A human performs positioning of the manipulator system and the manipulation of a manipulation target object using a remote control device. This manipulation is performed such that the control unit 47 decides an input signal 401 to the drive unit 1 using an output angle 402 of the drive unit 1. Next, the calculation unit 42 sequentially performs the identification of parameters based on an input signal to the drive unit 1 that the reception unit 41 acquired and an output angle 403 of the drive unit 1. The manipulator system can timely grip an operation state of the manipulator by calculating a spring coefficient and a mass sequentially at real time during its operation.

Further, the control unit 47 calculates an input signal for operating the manipulator at a desired position based on the measured position of the manipulator. The manipulator system includes a remote control unit that receives a manipulation performed by a human, and the control unit 47 can calculate instruction relating to a position or a force that the manipulator outputs based on the operation of the remote control unit.

It has been known that, at this point of time, in a case where frequency components that are contained in a signal inputted to an actuator from the control unit 47 are limited, there is a possibility that the identification of parameters is not performed in a stable manner. Accordingly, it is preferable that the manipulator system be driven in such a manner that the calculation-use signal generating unit 45 adds a M-sequence signal 407 having a signal size of an extent that a remote control by a human is not obstructed to an input obtained by a remote control. Due to the addition of the signal having a signal size of an extent that a remote control is not obstructed, the identification of parameters can be performed in a stable manner.

In step 205, the discrimination of an operation state is performed by the identification unit 44 in accordance with the operation performed in step 204. The identification unit 44 performs the discrimination of the operation state of the manipulator system corresponding to a parameter estimation result 404 in the calculation unit 42. The identification unit 44 discriminates three states consisting of a non-contact state, a contact state and a gripping state.

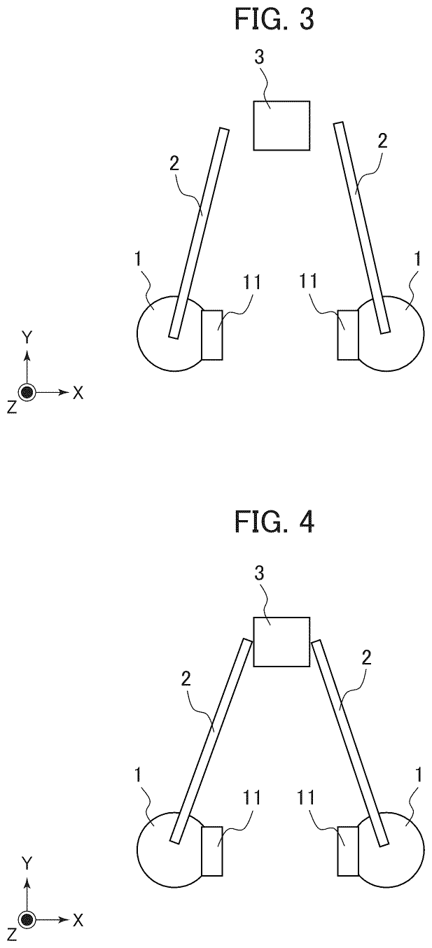

FIG. 3 illustrates an example of the manipulator system in a non-contact state. The non-contact state means a state where the manipulator and the manipulation target object are not brought into contact with each other so that the operation of the manipulator does not influence the operation target object.

FIG. 4 illustrates an example of the manipulator system in a contact state. The contact state means a state where, although the manipulator and the manipulation target object are brought into contact with each other, the manipulator and the manipulation target object are not integrally operated with each other. In FIG. 4, although the end effectors are operated in the X direction, the manipulation target object is not operated.

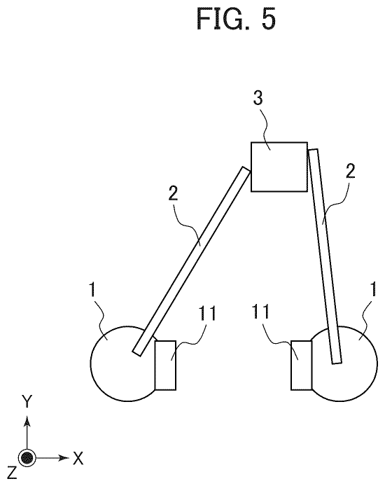

FIG. 5 illustrates an example of the manipulator system in a gripping state. The gripping state is a state where the manipulator grips the manipulation target object, and the manipulation target object is also operated together along with the operation of the manipulator. In FIG. 5, the manipulator grips the manipulation target object, and the manipulation target object is also operated in the X direction integrally with the operation of the end effectors in the X direction.

Next, the description is made with respect to the method of discriminating the operation state that uses the parameters estimated in the step 204. In a case where the operation state is a non-contact state, in step 204, the estimated mass and spring coefficient become substantially equal to a value 405 stored in the memory unit 43. Accordingly, in a case where a differential between the estimated mass and spring coefficient and a mass and a spring coefficient stored in the memory unit 43 is smaller than a predetermined threshold Kth and Mth, it is determined that the manipulator system is in a non-contact state with the manipulation target object 3.

In a case where the operation state is a contact state, an output angle for the same force becomes small and hence, the spring coefficient K of the manipulator system is increased. In a case where a differential between the spring coefficient K estimated in step 204 and the spring coefficient K of the manipulator system stored in the memory unit 43 is larger than a predetermined threshold Kth, it is determined that the manipulator system is in a contact state with the manipulation target object 3.

In a gripping state, the manipulation target object 3 is operated integrally with the manipulator system and hence, the mass M is increased. In a case where a differential between the mass estimated in step 204 and the mass of the manipulator system stored in the memory unit 43 is larger than a predetermined threshold Mth, it is determined that the manipulator system is gripping the manipulation target object 3.

As a method of deciding the threshold Kth of the spring coefficient and the threshold Mth of the mass, a method that decides these values preliminarily corresponding to a kind of the manipulation target object 3 or a method that decides by performing a test preliminarily are effective. As described above, the identification unit 44 can discriminate three states consisting of a non-contact state, a contact state, and a gripping state.

In addition to the above-mentioned discrimination method, auxiliarily, a method that performs discrimination using gain G or damping D may be also effective. For example, an output of the manipulator system becomes small in a contact state and hence, the gain G becomes small compared to a non-contact state. Accordingly, in a case where a differential between such a gain and a gain of the manipulator system stored in the memory unit becomes smaller than a predetermined threshold Gth, it is possible to perform the discrimination that the manipulator system is in a contact state with the manipulation target object 3. To enhance the accuracy and reliability of the state determination, it is effective to perform the determination together with a change in a spring coefficient.

Further, in a gripping state, the manipulator system and the manipulation target object are integrally operated and hence, viscous resistance at the time of operating is increased whereby damping D is increased. Accordingly, in a case where a differential between the gain and damping of the manipulator system stored in the memory unit becomes larger than a predetermined threshold Dth, it is possible to discriminate that the operation state is a gripping state. Also in this case, to enhance reliability of the state determination, it is effective to perform the determination together with a change in mass.

The method of identifying an operation state performed by the identification unit 44 is not limited to the above-mentioned method, and it is preferable to decide the operation state corresponding to the manipulator system to which the present invention is applied and the kind of a manipulation target object.

In step 206, in accordance with the operation state 406 identified in step 205, the switching of information 408 provided to the user is performed. Two ways exist for providing information to the user. On way is haptic information provided to a user via the remote control device, and the other way is visual information provided via an image.

First, the providing of haptic information is described. Haptic information is provided to a user by performing a control of the remote control device drive unit 5.

In a non-contact state, the device to which a remote control is applied is controlled such that the device is operated in accordance with the manipulation of the user, particularly, in such a manner that a reaction or the like is not provided to the manipulation performed by a user so that the manipulation is not obstructed.

In a contact state, a reaction is provided by way of a device to which a remote control is applied so as to prevent a manipulation that gives a damage to a manipulation target object after contacting from being performed. At this stage of the operation, it is effective to provide a reaction of a magnitude that is in proportion to a differential between the position where it is determined that the manipulator is brought into contact with the manipulation target object and a current position.

In a gripping state, that the current state is the gripping state is displayed on a screen for observing the target object while providing a reaction provided in a contact state. This display is described later. With the above-mentioned display, it is possible to recognize that the object is gripped by applying a proper force to the device to which a remote control is applied and hence, the safe manipulation can be realized.

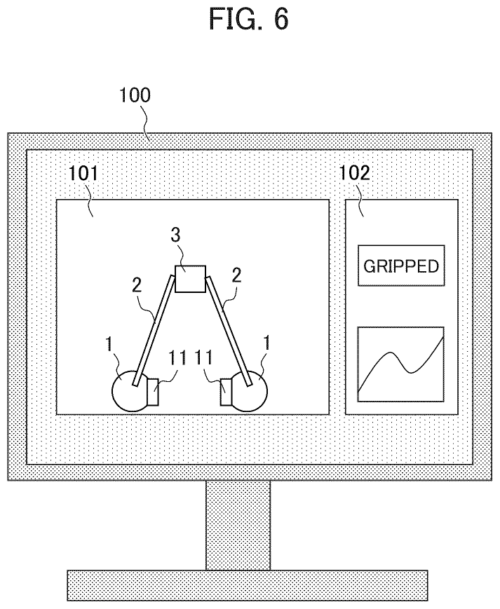

Next, the providing of visual information is described. FIG. 6 indicates an example of the screen that displays information provided to the user. A screen of an information providing unit 100 that provides the user with information is constituted of: a manipulation target object display unit 101 that displays an image of a manipulation target object that is acquired by the observation means 7 and an image of the manipulator system; and a state display unit 102 that displays a current state of the manipulator system.

The manipulation target object display unit 101 constantly displays an image acquired by the observation means 7, and provides the user with a situation around the manipulation target object. The state display unit 102 displays which state the manipulator system is among a non-contact state, a contact state and a gripping state by a visual means such as letters, for example. Accordingly, the user can visually discriminate the state of the manipulator system. It is effective to enhance visibility by using colors or the like in addition to letters. Further, it is also effective to display in the form of graphs a change with time in a physical quantity such as the position of the manipulator system.

After completion of processing in step 206, in a case where the manipulation of the target object is to be continued, the processing returns to step 204 and the processing from step 204 to step 206 is repeatedly performed until the operation of the manipulator system is completed. In a case where the manipulation of the target object is finished, the series of processing is also finished. It is desirable to perform arithmetic operation from step 204 to step 206 in a fast cycle as much as possible to speedily provide the user with the information.

Heretofore, the switching of information provided to the user by the control unit 47 has been described. However, it is also effective to switch the control modes by the control unit 47 corresponding to identified operation states. For example, in a non-contact state, it is preferable that the manipulator system performs the accurate positioning in accordance with the manipulation of the user. On the other hand, in a contact state or in a gripping state, the manipulator system is brought into contact with the manipulation target object. Accordingly, not to damage the manipulation target object, it is effective to switch a force that the manipulator system outputs to a force control to control the force by an identification unit. In this case, it is preferable to preliminarily check whether or not the estimation of parameters in the calculation unit is affected due to switching performed by the control unit 47.

The embodiment of the present invention has been described in detail with reference to the drawings. However, the specific configuration of the present invention is not limited to this embodiment. Design changes and the like that are made without departing from the gist of the present invention also fall within the scope of the present invention. The manipulator system of this disclosure is not limited to the manipulator according to this embodiment.

### LIST OF REFERENCE SIGNS

1: drive unit
2: end effector
3: manipulation target object
4: computer
5: remote control device drive unit
6: remote control device manipulation unit
7: observation means
11: drive unit output angle measuring unit
41: reception unit
42: calculation unit
43: memory unit
44: identification unit
45: calculation-use signal generation unit
46: output unit
47: control unit
51: remote control device drive unit angle measuring unit
100: information providing unit
101: manipulation target object display unit
102: state display unit

1. A manipulator system provided with a drive unit that drives a manipulator and a measurement unit that measures a position of the manipulator, the manipulator system comprising:
a memory unit configured to store a mass of the manipulator before the operation of manipulator and a spring coefficient of the manipulator before the operation of the manipulator;
a reception unit configured to receive an input signal that drives the manipulator, and an output signal of the manipulator that is operated in response to the input signal;
a calculation unit configured to calculate a mass of the manipulator during the operation of the manipulator and a spring coefficient of the manipulator during the operation of the manipulator using the input signal and output signal; and
an identification unit configured to identify an operation state of the manipulator by comparing the mass of the manipulator before the operation of manipulator and the spring coefficient of the manipulator before the operation of the manipulator both of which the memory unit stores, and the mass of the manipulator during the operation of the manipulator and the spring coefficient of the manipulator during the operation of the manipulator both of which the calculation unit calculates with each other, respectively.

2. The manipulator system according to claim 1 further comprising:
a control unit configured to decide a control mode of the manipulator using the operation state that the identification unit identifies; and
an output unit configured to output the control mode of the manipulator to the manipulator in response to the operation state of the manipulator that the identification unit identifies.

3. The manipulator system according to claim 1 further comprising:
a control unit configured to decide information to be provided to a user using the operation state of the manipulator that the identification unit identifies; and
an output unit configured to output the information to be provided to an information providing unit of the user in response to the operation state of the manipulator that the identification unit identifies.

4. The manipulator system according to claim 1,
wherein the calculation unit is configured to calculate a parameter of a physical model of the manipulator system to which modeling is applied preliminarily using the input signal that drives the manipulator and the output signal of the manipulator.

5. The manipulator system according to claim 1, further comprising
a calculation-use signal generating unit configured to output a signal for performing calculation of the spring coefficient and the mass in the calculation unit.

6. The manipulator system according to claim 1,
wherein the calculation unit is configured to calculate the spring coefficient and the mass sequentially real time during the operation of the manipulator system.

7. The manipulator system according to claim 1, further comprising
a control unit configured to calculate the input signal for operating the manipulator to a desired position based on a measured position of the manipulator.

8. The manipulator system according to claim 1, further comprising:
a control unit configured to calculate the input signal for operating the manipulator to a desired position based on a measured position of the manipulator; and
a remote control unit configured to receive a manipulation performed by a human,
wherein the control unit is configured to calculate an instruction of a position or a force that the manipulator outputs based on an operation of the remote control unit.

9. The manipulator system according to claim 1, further comprising:
an observing unit configured to observe a manipulation target object of the manipulator; and
a providing unit configured to be capable of providing a user with an image or a video of a manipulation target object acquired by the observing unit.

10. A management device that manages an operation state of a manipulator, the management device comprising:
a memory unit configured to store a mass of the manipulator before the operation of manipulator and a spring coefficient of the manipulator before the operation of manipulator;
a reception unit configured to receive an input signal that drives the manipulator, and an output signal of the manipulator that is operated in response to the input signal;
a calculation unit configured to calculate a mass of the manipulator during an operation of the manipulator and a spring coefficient of the manipulator during an operation of the manipulator using the input signal and the output signal; and
an identification unit configured to identify an operation state of the manipulator by comparing the mass of the manipulator before the operation of manipulator and the spring coefficient of the manipulator before the operation of manipulator both of which the memory unit stores, and the mass of the manipulator during the operation of the manipulator and the spring coefficient of the manipulator during the operation of the manipulator both of which the calculation unit calculates with each other, respectively.

11. The management device that manages an operation state of a manipulator according to claim 10 further comprising
a control unit configured to decide a control mode of the manipulator or information to be provided to a user using the operation state of the manipulator that the identification unit identifies.

12. A management method for managing an operation state of a manipulator, the management method comprising the steps of:
storing a mass of the manipulator before the operation of manipulator and a spring coefficient of the manipulator before the operation of manipulator;
receiving an input signal that drives the manipulator, and an output signal of the manipulator that is operated in response to the input signal;
calculating a mass of the manipulator during an operation of the manipulator and a spring coefficient of the manipulator during an operation of the manipulator using the input signal and the output signal; and
identifying an operation state of the manipulator by comparing the mass of the manipulator before the operation of manipulator and the spring coefficient of the manipulator before the operation of manipulator both of which are stored, and the mass of the manipulator during the operation of the manipulator and the spring coefficient of the manipulator during the operation of the manipulator both of which are calculated with each other, respectively.
